(19) United States
(12) Patent Application Publication
(10) Pub. No.: US 2012/0033923 A1
(43) Pub. Date: Feb. 9, 2012

(54) HOLEY SINGLE-MODE OPTICAL FIBER AND OPTICAL TRANSMISSION SYSTEM USING SAME

(75) Inventors: Katsuhiro TAKENAGA, Sakura-shi (JP); Shoji TANIGAWA, Sakura-shi (JP); Kazuhide NAKAJIMA, Tsukuba-shi (JP); Tomoya SHIMIZU, Tsukuba-shi (JP); Chisato FUKAI, Tsukuba-shi (JP)

(73) Assignees: NIPPON TELEGRAPH AND TELEPHONE CORPORATION, Tokyo (JP); FUJIKURA LTD., Tokyo (JP)

(21) Appl. No.: 13/273,813

(22) Filed: Oct. 14, 2011

Related U.S. Application Data
(63) Continuation of application No. PCT/JP2010/002887, filed on Apr. 21, 2010.

(30) Foreign Application Priority Data
Apr. 21, 2009 (JP) 2009-103224

(51) Int. Cl. G02B 6/032

(52) U.S. Cl. 385/125

(57) ABSTRACT

Provided is a holey single-mode optical fiber including a core not having holes, and a clad having holes extending in a longitudinal direction, in which a refraction index of the core is larger than that of a portion of the clad other than the holes, a radius r₁ of the core is within a range of 2.2 to 3.2 μm, a relative refraction index difference Δ of the core to the clad is within a range of 0.3 to 0.56%, a distance Rᵢₙ between a center of the core and an inner edge of the holes is 2.0 to 3.5 times the radius r₁ of the core, an air-filling fraction F is within a range of 30 to 50%, a cable cut-off wavelength is 1.0 μm or less, a zero-dispersion wavelength is within a range of 1260 to 1460 nm, and a bending loss characteristic at a bending radius of 10 mm is 10 dB/m or less.

### CROSS-REFERENCE TO RELATED APPLICATION

This is a Continuation Application of International Application No. PCT/JP2010/002887, filed on Apr. 21, 2010, which claims priority to Japanese Patent Application No. 2009-103224 filed on Apr. 21, 2009. The contents of the aforementioned applications are incorporated herein by reference.

### BACKGROUND OF THE INVENTION

1. Field of the Invention

The present invention relates to a holey single-mode optical fiber and an optical transmission system using the same.

2. Description of the Related Art

In recent years, as broad band services increase, transmission capacities have been increasing remarkably. When considering the increase in transmission capacity, which is expected in the future, it is necessary to develop a new communication wavelength band. Light with a wavelength band of 1.0 μm has attracted attention as a Yb doped optical fiber amplifier (YDFA) is able to be used, such that it has been suggested to transmit the light by using a wavelength division multiplexing (WDM) in a remarkably wide wavelength range of 1.0 to 1.55 μm (for example, see Non-Patent Document 1).

In Non-Patent Document 1, it is suggested that a special optical fiber called a photonic crystal fiber (PCF) be used as a transmission medium. FIG. 21 shows a schematic diagram illustrating a cross section of the PCF, in which 60 holes are formed.

In addition, in Patent Document 1 and Non-Patent Document 2, there is suggested a hole-assisted fiber (HAF) in consideration of a propagation of light with a wavelength of 1 μm.

In addition, in Patent Document 2, there is suggested a holey single single-mode optical fiber having a property strong against bending loss. This fiber is made to have holes, such that optical characteristics such as a mode field diameter (MFD) and a dispersion characteristic are compliant to ITU-T (International Telecommunication Union Telecommunication standardization sector) recommendation G.652 while suppressing the bending loss to a sufficiently small amount.

In addition, in Patent Document 3, there is suggested an optical fiber in which a long distance and high-speed transmission at a wavelength of 1.31 μm is performed using a HAF, such that a zero-dispersion wavelength is maintained within a range of 1300 to 1320 nm while realizing a remarkably small bending loss.

In addition, in Patent Document 4, there is suggested a HAF in which holes formed in a clad part are disposed to wrap around a core part in two layers or more, thereby having a property strongly resistant to bending loss. In addition, in these specifications, it is pointed out that, with one layer of holes, a light confinement in a long wavelength side is weak and thereby the transmission loss becomes large.

In addition, in Patent Document 5, there is disclosed a microstructure optical fiber in which a clad having a refraction index lower than that of a core has an area where closed voids are non-periodically disposed, and in which a void pattern and a void size in a cross section of the optical fiber are irregular (random).

In addition, in Non-Patent Document 3, there is disclosed a method in which, when an optical fiber having holes is spliced to a general single mode fiber (SMF) not having a hole, an intermittent discharge or a sweep discharge is performed and thereby the holes are collapsed into a tapered shape, such that the optical fiber is fusion-spliced to the SMF with an average splice loss of 0.05 dB.

### Patent Documents

[Patent Document 1] International Publication No. 2008/062834
[Patent Document 2] Japanese Patent No. 3854627
[Patent Document 3] Japanese Patent No. 3909397
[Patent Document 4] Japanese Unexamined Patent Application, First Publication No. 2005-25056
[Patent Document 5] Specification of U.S. Pat. No. 7,450,806

### Non-Patent Documents

[Non-Patent Document 1] K. Kurokawa, K. Tsujikawa, K. Tajima, K. Nakajima and I. Sankawa, “10 Gb/s WDM transmission at 1064 and 1550 nm over 24 km PCF with negative power penalties”, OECC/IOOC2007 Technical Digest, July 2007, 12C 1-3
[Non-Patent Document 2] K. Mukasa, R. Miyabe, K. Imamura, K. Aiso, R. Sugizaki and T. Yagi, “Hole Assisted Fibers (HAFs) and Holey Fibers (HFs) for short-wavelength applications”, Optics East 2007, 2007, 6779-18
[Non-Patent Document 3] Ryuji Suzuki et al., “a study of a fusion splicing method for holey fibers”, Institute of Electronics, Information and Communication Engineers (IEICE) Electronics Society Symposium, C-3-119, 2004

However, in the related art, there are problems as described below.

In the PCF 100 (see FIG. 21) used in Non-Patent Document 1, since the number of holes 102 is remarkably large, that is, 36 to 90, it is very difficult to manufacture and is expensive. In addition, since a material of a center portion 103 and a material of a clad 101 are the same, in a case where holes are collapsed by a fusion splicing or the like, there is a problem in that a wave guide structure is locally absent and a loss at a splicing portion becomes large.

In the HAF used in Patent Document 1 and Non-Patent Document 2, since a zero-dispersion wavelength is near 1.0 μm, a chromatic dispersion becomes large at a wavelength of 1.55 μm or 1.625 μm, such that a waveform is distorted and thereby it becomes difficult to increase a transmission capacity. Therefore, it becomes difficult to perform a WDM transmission across the entire wide wavelength band of a wavelength of 1.0 to 1.625 μm. In addition, since holes are formed at positions adjacent to a core, it is difficult to remove a loss caused by irregularity of a hole portion or an absorption loss caused by a hydroxyl (OH) group and thereby it is difficult to reduce the loss.

In the holey single-mode optical fiber used in Patent Document 2, since a parameter is set in an operating wavelength region of 1260 to 1625 nm, it is difficult to make a cable cut-off wavelength smaller than or equal to 1.0 μm.

In the HAF used in Patent Document 3, attention is not given to a transmission near 1.0 μm, and there is not disclosed a technique to make a cable cut-off wavelength smaller than or equal to 1.0 μm.

In the PCF used in Patent Document 4, since the number of holes is large, it is difficult to manufacture and is expensive.

In general, in a case where a cable cut-off wavelength is made to be 1.0 μm or less in an optical fiber not having holes, there is a method of making a relative refraction index difference between a core and a clad become small and a method of making the relative refraction index difference be large and making a core diameter become small.

In the method of making the relative refraction index difference become small, the resultant fiber has a large bending loss in a long wavelength (for example, a wavelength band of a wavelength of 1550 nm or more) and thereby becomes a fiber not suitable for using the wavelength band of 1550 nm as a communication wavelength.

In the method of making the relative refraction index difference become large, according to a simulation performed by the present inventors, it is possible to realize an MFD at a wavelength of 1.31 μm that has a size of about 6.4 μm while satisfying the requirement that a cable cut-off wavelength is 1.0 μm or less and a bending loss is 10 dB/m or less (at a wavelength of 1.625 μm and a bending radius r of 10 mm). However, the MFD becomes remarkably small.

The present invention was made in consideration of such a circumstance, and an object thereof is to provide an optical fiber that can be easily made and is capable of communicating over a wide wavelength range (for example, a wavelength of 1.0 to 1.625 μm).

### SUMMARY

To solve the above-described problems, there is provided a holey single-mode optical fiber including a core not having holes, and a clad having holes extending in a longitudinal direction, in which a refraction index of the core is larger than that of a portion of the clad other than the holes, a radius r₁ of the core is within a range of 2.2 to 3.2 μm, a relative refraction index difference Δ of the core to the clad is within a range of 0.3 to 0.56%, a distance Rᵢₙ between a center of the core and an inner edge of the holes is 2.0 to 3.5 times the radius r₁ of the core, an air-filling fraction F is within a range of 30 to 50%, a cable cut-off wavelength is 1.0 μM or less, a zero-dispersion wavelength is within a range of 1260 to 1460 nm, and a bending loss characteristic at a bending radius of 10 mm is 10 dB/m or less.

The holey single-mode optical fiber of the present invention may adopt a configuration where in the clad, 8 or more holes are disposed to be equally spaced in a single concentric circle.

In addition, it may adopt a configuration where a mode field diameter at a wavelength of 1.31 μm is 6.5 μm or more.

In addition, it may adopt a configuration where a loss at a wavelength of 1550 nm is 0.3 dB/km or less.

In addition, it may adopt a configuration where a splice loss per one fusion splicing place with another optical fiber is 1.0 dB or less.

In addition, it may adopt a configuration where a bending loss characteristic at a bending radius of 10 mm is 1 dB/m or less.

In addition, it may adopt a configuration where the zero-dispersion wavelength is within a range of 1300 to 1324 nm.

In addition, it may adopt a configuration where an outer diameter of the clad is 150 μm or more.

In addition, it may adopt a configuration where a coating covering an outer circumference of the clad is further provided wherein an outer diameter of the coating is 350 μm or more.

In addition, it may adopt a configuration where the core is made of pure silica.

In addition, there is provided an optical transmission system, in which a wavelength division multiplexing transmission is performed within a wavelength range of 1.0 to 1.625 μm.

According to the present invention, by optimizing a parameter of an optical fiber (HAF) structure where a core with a large refraction index is provided at a center portion and holes are provided at the periphery of the core, it is possible to realize an optical fiber that has a cable cut-off wavelength of 1.0 μm or less, has a bending loss of 10 dB/m or less at a bending radius r of 10 mm over a wavelength of 1.0 to 1.625 μm, maintains a zero-dispersion wavelength between 1260 and 1460 nm, and has a small splice loss. Therefore, a WDM transmission at a wavelength of 1.0 to 1.625 μm may be possible. In addition, since the number of holes is small, it is possible to easily manufacture an optical fiber at a low cost.

### BRIEF DESCRIPTION OF THE DRAWINGS

FIG. 1A is a cross sectional view illustrating an embodiment of a holey single-mode optical fiber of the present invention.

FIG. 1B is an enlarged cross sectional view illustrating a portion of the embodiment.

FIG. 2 is a graph illustrating a simulation result of a single mode optical fiber having a step-type profile, which does not have holes.

FIG. 3 is a graph illustrating a measurement result of a difference of zero-dispersion wavelengths obtained by subtracting a zero-dispersion wavelength of an optical fiber not having holes from a zero-dispersion wavelength of an optical fiber having holes.

FIG. 4 is a graph illustrating a dispersion measurement result of a fiber B.

FIG. 5 is a graph illustrating a dispersion measurement result of a fiber E.

FIG. 6 is a graph illustrating an evaluation result of a splice loss of the fiber B.

FIG. 7 is a cross sectional view schematically illustrating a state where holes are collapsed at a fusion splicing portion.

FIG. 8 is a graph illustrating a result of evaluation on a splice loss of the fiber B at the splicing state shown in FIG. 7.

FIG. 9 is a graph illustrating a dispersion measurement result of a fiber F.

FIG. 10 is a graph illustrating a dispersion measurement result of a fiber H.

FIG. 11 is a graph illustrating a dispersion measurement result of a fiber I.

FIG. 12 is a graph illustrating a result of evaluation on microbending characteristics of fibers F, G and H.

FIG. 13 is a graph illustrating a result of evaluation on an attenuation characteristic of the fiber F.

FIG. 14 is a graph illustrating a result of evaluation on an attenuation characteristic of the fiber G.

FIG. 15 is a graph illustrating a result of evaluation on an attenuation characteristic of the fiber H.

FIG. 16 is a cross sectional view schematically illustrating an example of a holey single-mode optical fiber of which the number of holes is 4.

FIG. 17 is a cross sectional view schematically illustrating an example of a holey single-mode optical fiber of which the number of holes is 6.

FIG. 18 is a cross sectional view schematically illustrating an example of a holey single-mode optical fiber of which the number of holes is 8.

FIG. 19 is a cross sectional view schematically illustrating an example of an optical fiber, in which a diameter of the fiber is 125 μm and a diameter of a coating is 250 μm.

FIG. 20 is a cross sectional view schematically illustrating an example of an optical fiber, in which the diameter of the fiber is 125 μm and the diameter of a coating is 350 μm.

FIG. 21 is a cross sectional view illustrating an example of a photonic crystal fiber in the related art.

### EMBODIMENTS FOR CARRYING OUT THE INVENTION

Hereinafter, the present invention will be described with reference to drawings on the basis of a preferred embodiment.

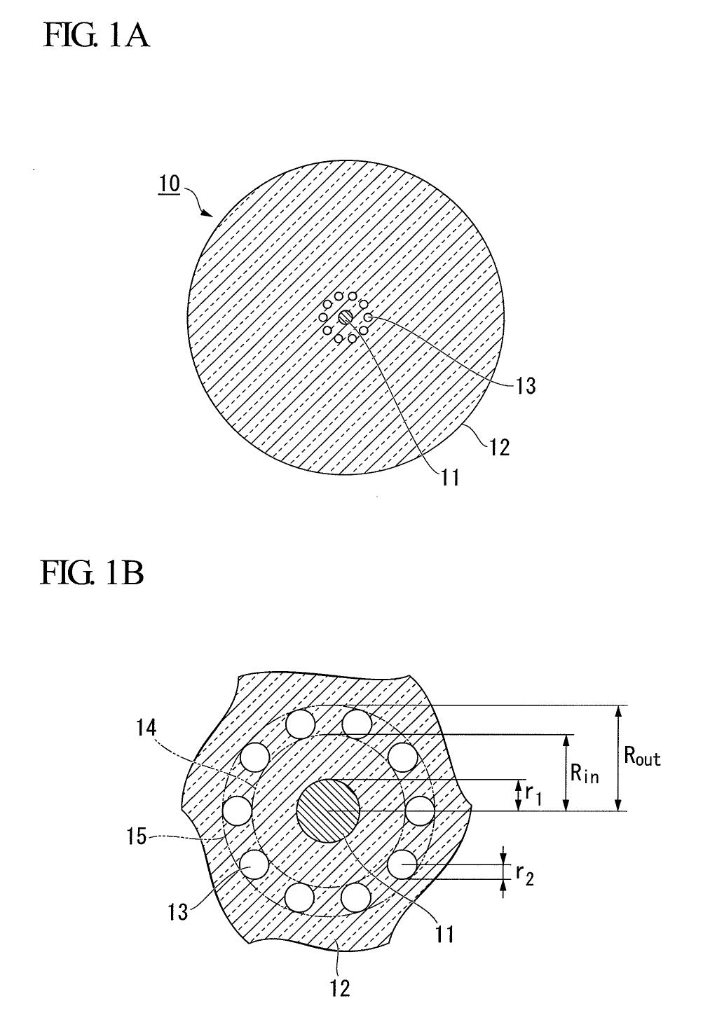

FIGS. 1A and 1B show an example of a holey single-mode optical fiber 10 according to this embodiment. The holey single-mode optical fiber 10 is configured by a hole-assisted fiber (HAF), in which a core 11 having a high refraction index is disposed at a center of the optical fiber 10 and a clad 12 having holes 13 is disposed at a periphery of the core 11. Therefore, by optimizing a parameter of the optical fiber as described below, it is possible to realize an optical fiber that at a cable cut-off wavelength of 1.0 μm or less, has a bending loss of 10 dB/m or less at a bending radius r of 10 mm over a wavelength of 1.0 to 1.625 μm, maintains a zero-dispersion wavelength between 1260 and 1460 nm (between 0 band and E band), and has a small splice loss. In addition, a bending loss of a general single mode fiber is about 20 dB/m (at a wavelength of 1.625 μm and a bending radius r of 10 mm).

In a case of a high capacity transmission, it is effective to perform a dense wavelength division multiplexing (DWDM) where a wavelength is multiplexed at high density, in addition to increasing a transmission speed at one wavelength. However, in a case of multiplexing a wavelength multiplexing at high density, a nonlinear phenomenon such as a cross phase modulation (XPM) and a four-wave mixing (FWM) is generated and this may cause a problem when increasing a transmission capacity. To suppress the nonlinear phenomenon, it is necessary to increase a mode field diameter (MFD) or an effective cross-sectional area (A_{eff}) of an optical fiber, or to increase a chromatic dispersion at a transmission wavelength. In particular, in a wavelength band where the wavelength is multiplexed at high density, it is important to increase the chromatic dispersion in addition to increasing the MFD or A_{eff} for suppressing the XPM or FWM. In a case of performing a high capacity transmission by using a wide wavelength range such as a wavelength of 1.0 to 1.625 μm, it is preferable that the DWDM is performed in a C band (1530 to 1565 nm) and a L band (1565 to 1625 nm) that have been already technically established, and at a wavelength band of 1.0 μm (1.0 to 1.2 μm) where a wide band amplification can be performed by using a Yb doped optical fiber amplifier. From the requirements described above, it is preferable that the MFD is made to be large and that the zero-dispersion wavelength is made to be a wavelength of an O band (1260 to 1360 nm) or an E band (1360 to 1460 nm) that is a wavelength other than the 1.0 μm band, the C band and the L band.

The holey single-mode optical fiber 10 of this embodiment has a zero-dispersion wavelength λ₀ of 1260 to 1460 nm, such that it has a dispersion value with a large absolute value at a wavelength band of 1.0 μm and 1.55 μm. Therefore, it is possible to suppress a nonlinear phenomenon such as a four-wave mixing (FWM) and thereby it is suitable to a dense wavelength transmission at two wavelength bands. By designing a dispersion as described above, a wavelength division multiplexing transmission (WDM transmission), for example, with four wavelengths or more at a wavelength band of 1.0 μm or with four wavelengths or more at a wavelength of 1.55 μm becomes possible, and thereby a transmission can be made at a wavelength of 1.31 μm, 1.49 μm, or the like. In addition, when a wavelength is made to be dense, a WDM transmission with 12 wavelengths or more at a wavelength band of 1.0 μm or with 128 wavelengths or more at a wavelength of 1.55 μm becomes possible, and also a transmission can be made at a wavelength of 1.31 μm, 1.49 μm, or the like.

The holey single-mode optical fiber of the present invention can be suitably used as an optical transmission system where a wavelength division multiplexing transmission is performed at a wavelength of from 1.0 to 1.625 μm.

In a WDM transmission, an optical signal is transmitted with a plurality of transmission wavelengths. According to the present invention, at both a wavelength band of 1.0 μm (1.0 to 1.2 μm) and a wavelength band of 1.55 μm (1530 to 1625 nm), even when at least one transmission wavelength is included, respectively (preferably, a plurality of transmission wavelengths, respectively), a transmission at both wavelength bands becomes possible. In addition, a transmission wavelength may be included between both wavelength bands (between 1.2 μm and 1.53 μm).

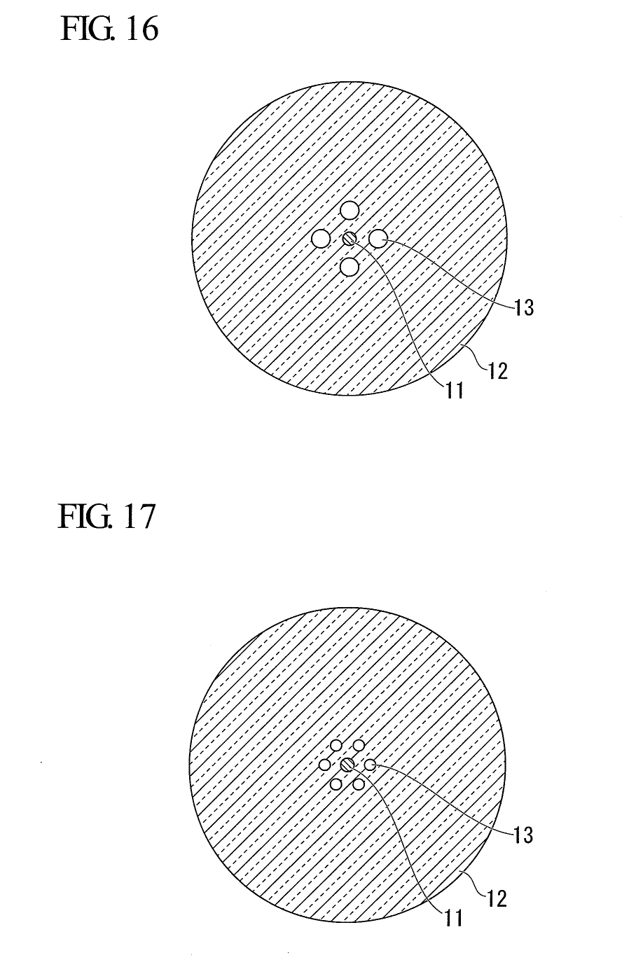

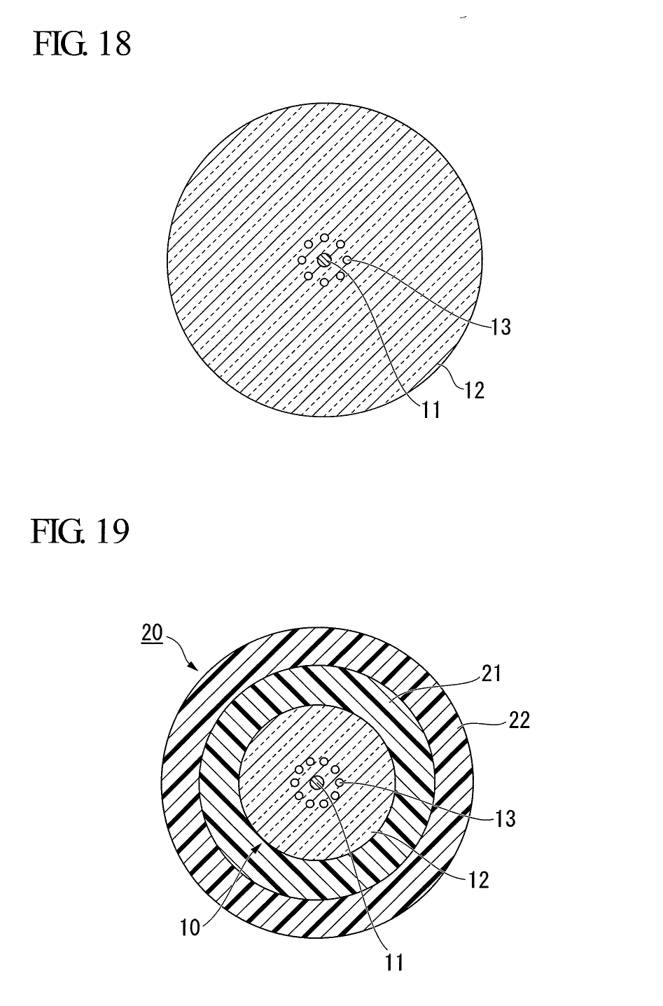

In FIGS. 1A and 1B, the holey single-mode optical fiber 10 is shown to have 10 holes 13. In the present invention, as shown in FIGS. 16, 17, and 18, the number of holes 13 may be even numbers of 4, 6, 8, or the like, or may be odd numbers of 7, 9, or the like (not shown). Preferably, the number of holes 13 is a plural number (4 or more), and more preferably is 8 or more. In a cross section cut out along a direction orthogonal to an optical axis of an optical fiber, it is preferable that the holes 13 are disposed to be equally spaced in a single layer with a concentric circle shape.

Here, as shown in FIG. 1B, a core radius is set to r₁, a hole radius is set to r₂, a radius of an inscribed circle 14 connecting an inner edge of each of the holes 13 is set to Rᵢₙ, and a radius of a circumscribed circle 15 connecting an outer edge of each of the holes 13 is set to Rₒᵤₜ. When the number of the holes 13 is set to N, an area ratio of a region where the holes are formed, which is represented by an equation (1) described below, is called an air-filling fraction F (unit %)

$$\begin{matrix}[ Equation 1 ] & \\ F = \frac{N \cdot π \cdot {r}_{2}^{2}}{π ( {R}_{out}^{2} - {R}_{in}^{2} )} \times 100 & ( 1 )\end{matrix}$$

In addition, as is the case with the single-mode optical fiber in the related art, a refraction index n₁ of the core 11 is made to be larger than a refraction index n₂ of the clad 12 to form a wave guide structure. A relative refraction index difference Δ between the core 11 and the clad 12 (unit %) is defined by an equation 2 described below by using each of the refraction indexes n₁ and n₂.

$$\begin{matrix}[ Equation 2 ] & \\ Δ = \frac{{n}_{1}^{2} - {n}_{2}^{2}}{2 \cdot {n}_{1}^{2}} \times 100 & ( 2 )\end{matrix}$$

As methods for increasing the refraction index of the core 11, two methods have been known, that is, a method of adding an additive material (for example, a dopant such as germanium (Ge)) for increasing the refraction index to the core 11 and a method of adding an additive material (for example, a dopant such as fluorine (F)) for decreasing the refraction index to the clad 12 have been known, and either one of the methods may be adopted for the present invention.

In addition, a refraction index distribution of the core 11 is not limited to a step-type profile (meaning a refraction index distribution where a parameter g of a refraction index distribution satisfies 10≦g<∞ and corresponds to a refraction index distribution of a step-index type optical fiber defined by JIS S C 6820), and it is possible to use any refraction index distribution similarly to the single-mode optical fiber of the related art.

In the present invention, to optimize a parameter of an HAF structure, first, as described below, an examination is made with respect to an optical fiber not having holes on the basis of a simulation where a W-type profile and a step-type profile are used.

In general, as a method where a cable cut-off wavelength is made to be 1.0 μm or less with respect to an optical fiber not having holes, there is a method of making a relative refraction index difference between a core and a clad become small and a method of making the relative refraction index difference large and making the core diameter small.

In the method of making the relative refraction index difference become small, the resultant optical fiber has a large bending loss at a long wavelength (for example, a wavelength band of a wavelength of 1550 nm or more) and thereby becomes a fiber not suitable for using the wavelength band of 1550 nm as the communication wavelength.

In the method of making the relative refraction index difference become large, according to a simulation performed by the inventors, it is possible to realize an MFD at a wavelength of 1.31 μm that has a size of about 6.4 μm, while satisfying a requirement where a cable cut-off wavelength is 1.0 μm or less and a bending loss is 10 dB/m or less (at a wavelength of 1.625 μm and a bending radius r of 10 mm). However, the MFD becomes remarkably small. Here, the simulation performed by the inventors relates to a case where a W-type profile (a refraction index distribution where a low refraction index layer of which a refraction index is lower than either a core or a clad is provided between the core and the clad with a concentric circle shape) is used as a refraction index profile of a core with respect to an optical fiber not having holes. The MFD at other wavelengths was as follows: 5.5 μm at a wavelength of 1.06 μm, 7.4 μm at a wavelength of 1.55 μm and 7.8 μm at a wavelength of 1.625 μm.

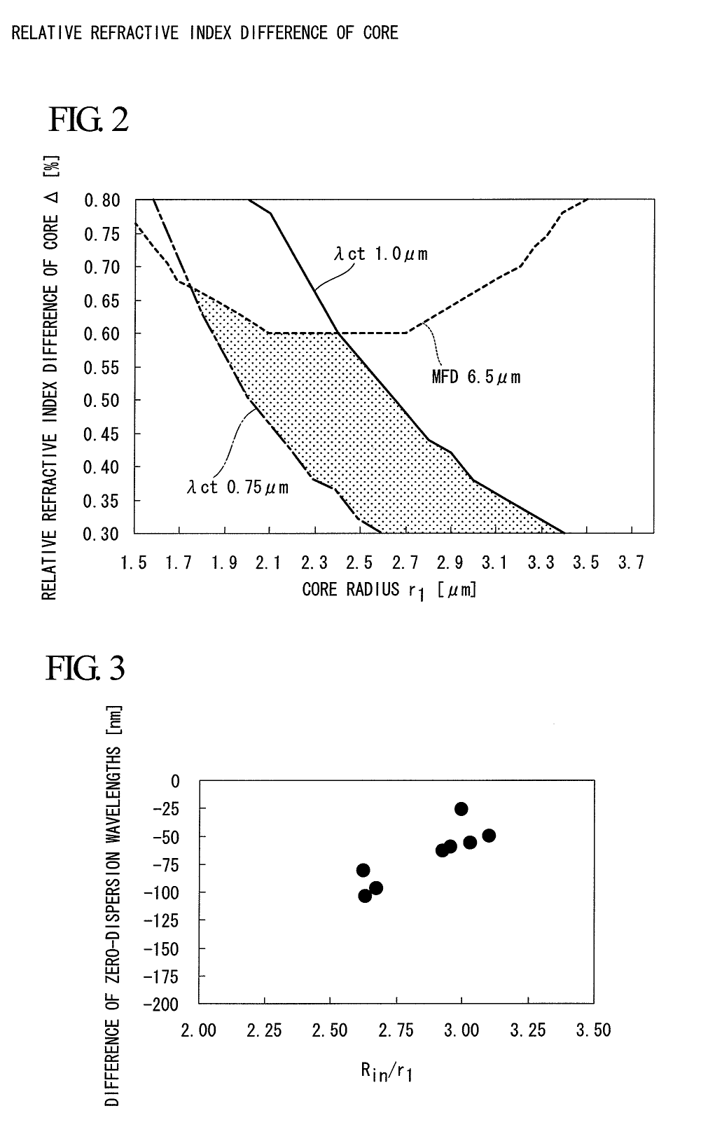

In addition, FIG. 2 shows a result of calculating a region where a theoretical cut-off wavelength is from 0.75 to 1.0 μm and an MFD at a wavelength of 1.31 μm is 6.5 μm or more, with respect to a single-mode optical fiber having a step-type profile not having holes. In FIG. 2, a region satisfying a condition is shown as a shaded region.

Here, the reason for setting a lower limit of the theoretical cut-off wavelength to 0.75 μm is that when the theoretical cut-off wavelength is less than 0.75 μm, light confinement in a core becomes remarkably weak and a transmission loss and a bending loss are deteriorated at a long wavelength such as a wavelength of 1.625 μm.

Next, since it is known that a zero-dispersion wavelength becomes large and shifts toward a long wavelength side by forming holes (see Patent Document 3), an HAF having a relative refraction index difference Δ and a core radius r₁ of the shaded region shown in FIG. 2 is manufactured, and how much the zero-dispersion wavelength is shifted with respect to a hole position according to the existence or non-existence of the holes is examined. The result thereof is shown in FIG. 3. Here, the HAF is manufactured such that an air-filling fraction F is set to 30 to 45% and the hole position is changed. From the result, it can be seen that as the position of each of the holes 13 becomes adjacent to the core 11, the zero-dispersion wavelength shifts toward a short wavelength side. It can be seen that at a hole position where Rᵢₙ/r₁=2.0, which is normalized by the core radius r₁, the zero-dispersion wavelength shifts by about 200 nm at the most and almost does not shift at all at a hole position where Rᵢₙ/r₁=3.5. Therefore, when the hole position Rᵢₙ/r₁ of the HAF is 2.0 or more, to make the zero-dispersion wavelength of the HAF be within a range of 1260 to 1460 nm, the range of zero-dispersion wavelength permitted in a design of a step-type profile not having holes becomes from 1260 to 1660 nm. The range of the zero-dispersion wavelength is true for all regions satisfying the requirements shown in FIG. 2 through the simulation.

In addition, to optimize the structure parameter of the HAF, the HAF is manufactured by examples described below and thereby conditions (1) to (4) below are founded.

(1) a core radius r₁ is within a range of 2.2 to 3.2 μm.

(2) a relative refraction index difference Δ of a core to a clad is within a range of from 0.3 to 0.56%.

(3) a distance Rᵢₙ between a center of the core and an inner edge of the holes is 2.0 to 3.5 times the core radius r₁.

(4) an air-filling fraction F is within a range of from 30 to 50%.

An outer diameter of the holey single-mode optical fiber 10 is not specifically limited, but it is preferable that in a case where the optical fiber is spliced to another optical fiber by fusion splicing, a mechanical splice, or the like (the details are described later), the outer diameter is in the same range as that of another optical fiber. In a case of a general silica-based optical fiber, a clad diameter (external diameter of a glass portion) is 80 to 125 μm (for example, 80 μm, 125 μm) and an outer diameter of a strand including a resin coating is 250 to 400 μm (for example, 250 μm, 400 μm), such that the external diameter of the holey single-mode optical fiber 10 may be the same as that described above.

In addition, in the optical fiber, the clad diameter may be 150 μm or more, and the outer diameter of the coating covering an outer circumference of the clad may be 350 μm or more.

The holey single-mode optical fiber 10 of the present invention includes the core 11 having a refraction index larger than that of a portion of the clad 12 other than the holes 13. Therefore, even when a periphery of the holes 13 is melted down at the time of fusion-splicing the optical fiber and thereby the holes 13 are collapsed, or even when a refraction index alignment agent is inserted into the holes 13, it is possible to maintain a wave guide structure. Therefore, it is possible to remarkably decrease a splice loss at the time of fusion-splicing the holey single-mode optical fiber 10 to a single-mode optical fiber, as disclosed in Non-Patent Document 3.

The core 11 and the clad 12 of the holey single-mode optical fiber 10 can be made of, for example, a silica-based glass material. A material of the core 11 is selected from materials having a refraction index larger than that of a material of the clad 12 (more specifically, a portion other than the holes 13). For example, a combination where the core 11 is made of a germanium (specifically, GeO₂)-doped silica glass and the clad 12 is made of a pure silica glass and a combination where the core 11 is made of a pure silica glass and the clad 12 is made of a fluorine (F)-doped silica glass may be exemplified.

As a dopant used for increasing a refraction index of a silica-based glass, aluminum (Al), phosphorus (P), or the like in addition to Ge is an exemplary example. In addition, as a dopant used for decreasing a refraction index of a silica-based glass, F, boron (B), or the like are exemplary examples.

A configuration for obtaining a relative refraction index difference between the core 11 and the clad 12 is not limited to a case where a dopant for increasing a refraction index is added only to the core 11 or a dopant for decreasing a refraction index is added only to the clad 12. To make the core 11 have a refraction index larger than that of the clad 12, one or more kinds of dopant for increasing a refraction index and one or more kinds of dopant for decreasing a refraction index may be doped to the core 11, respectively. In addition, to make the clad 12 have a refraction index smaller than that of the core 11, one or more kinds of dopant for increasing a refraction index and one or more kinds of dopant for decreasing a refraction index may be doped to the clad 12, respectively. In addition, one or more kinds of dopant may be doped to the core 11 and the clad 12, respectively.

Since splicing between the holey single-mode optical fibers 10 or between the holey single-mode optical fiber 10 and another optical fiber (general SMF or the like) can be performed with a relatively low loss and thereby the long-term reliability thereof is excellent, and fusion splicing is preferable. As a method for the fusion splicing, as disclosed in Non-Patent Document 3, it is preferable to collapse the holes of the HAF into a tapered shape by an intermittent discharge or a sweep discharge. In a case of the HAF having one-layered holes around the core 11, the sweep discharge is preferable.

### EXAMPLES

As described below, an HAF is actually manufactured with respect to a case where a refraction index of the clad 12 is set to a pure silica level, a refraction index of the holes 13 is set to 1 (air), the core 11 is made of a silica glass of which the refraction index is increased by using germanium (Ge) as a dopant material, and a step-type refraction index distribution is shown, and the relationship between structure parameters and optical characteristics is obtained.

A cable cut-off wavelength represents a value measured by a measurement standard of an optical fiber, that is, a 7.6.1 Cable cut-off method of IEC 60793-1-44. In addition, in a case where the number of holes is varied, a correlation of each of the optical characteristics increases when using an air-filling fraction F rather than when using a hole diameter, such that the air-filling fraction F shown in the above-described equation (1) is used.

Structure parameters and main optical characteristics of each of the optical fibers manufactured in examples described below are shown in Table 1. In Table 1, a mode field diameter (MFD) [μm] is a value at a wavelength of 1.31 μm. In addition, a bending loss [dB/m] is a value at a wavelength of 1.625 μm and a bending radius r of 10 mm.

TABLE 1

| | | | | | | Radius | | | Outer | | Zero- | | | |
|---|---|---|---|---|---|---|---|---|---|---|---|---|---|---|
| | Relative | | | Radius | | of a | | | diam- | | dis- | Cable | mode | |
| | refraction | | The | of an | | circum- | | Air- | eter | Coating | persion | cut-off | field | |
| | index | Core | number | inscribed | Hole | scribed | | filling | of a | diam- | wave- | wave- | diam- | |
| | difference | radius | of holes | circle | radius | circle | Hole | fraction | clad | eter | length | length | eter | Bending |
| | Δ | r₁ | N | Rᵢₙ | r₂ | Rₒᵤₜ | position | F | D_{clad} | D | λ₀ | λ_{cc} | MFD | loss |
| Fiber ID | [%] | [μm] | [number] | [μm] | [μm] | [μm] | Rᵢₙ/r₁ | [%] | [μm] | [μm] | [μm] | [μm] | [μm] | [dB/m] |
| Fiber A | 0.39 | 2.7 | 10 | 7.22 | 1.12 | 9.46 | 2.67 | 33.7 | 125 | 250 | 1.311 | 0.91 | 7.4 | 2.7 |
| Fiber B | 0.39 | 2.7 | 10 | 7.11 | 1.61 | 10.32 | 2.63 | 46.0 | 125 | 250 | 1.304 | 0.94 | 7.4 | 0.62 |
| Fiber C | 0.39 | 2.7 | 10 | 7.05 | 1.77 | 10.58 | 2.61 | 50.1 | 125 | 250 | 1.296 | 0.99 | 7.3 | 0.50 |
| Fiber D | 0.39 | 2.7 | 10 | 7.02 | 1.94 | 10.90 | 2.60 | 54.1 | 125 | 250 | 1.285 | 1.10 | 7.2 | 0.10 |
| Fiber E | 0.39 | 2.7 | — | — | — | — | — | — | 125 | 250 | 1.407 | 0.86 | 7.9 | >100 |
| Fiber F | 0.33 | 3.2 | 10 | 9.77 | 0.93 | 11.63 | 3.05 | 21.7 | 125 | 250 | 1.343 | 0.89 | 8.4 | 37.4 |
| Fiber G | 0.33 | 3.2 | 10 | 9.54 | 1.39 | 12.32 | 2.98 | 31.8 | 125 | 250 | 1.337 | 0.91 | 8.4 | 6.8 |
| Fiber H | 0.33 | 3.2 | 10 | 9.31 | 1.54 | 12.39 | 2.91 | 35.5 | 125 | 250 | 1.334 | 0.90 | 8.4 | 4.71 |
| Fiber I | 0.33 | 3.2 | — | — | — | — | — | — | 125 | 250 | 1.393 | 0.84 | 8.7 | >100 |
| Fiber J | 0.39 | 2.7 | 10 | 4.90 | 0.80 | 6.50 | 1.81 | 35.1 | 125 | 250 | 1.223 | 0.85 | 6.8 | 6.2 |
| Fiber K | 0.39 | 2.7 | 10 | 5.50 | 0.93 | 7.35 | 2.04 | 36.0 | 125 | 250 | 1.262 | 0.88 | 7.0 | 7.3 |
| Fiber L | 0.39 | 2.7 | 10 | 9.40 | 1.55 | 12.50 | 3.48 | 35.4 | 125 | 250 | 1.402 | 0.99 | 7.8 | 8.2 |
| Fiber M | 0.39 | 2.7 | 10 | 10.00 | 1.60 | 13.20 | 3.70 | 34.5 | 125 | 250 | 1.405 | 1.15 | 7.8 | 8.3 |
| Fiber N | 0.28 | 3.4 | 10 | 8.90 | 1.40 | 11.70 | 2.62 | 34.0 | 125 | 250 | 1.281 | 0.95 | 9.1 | 14.3 |
| Fiber O | 0.30 | 3.2 | 10 | 8.70 | 1.49 | 11.68 | 2.72 | 36.6 | 125 | 250 | 1.293 | 0.96 | 8.8 | 9.5 |
| Fiber P | 0.56 | 2.2 | 10 | 6.05 | 1.08 | 8.21 | 2.75 | 37.9 | 125 | 250 | 1.450 | 0.89 | 6.5 | 0.91 |
| Fiber Q | 0.60 | 2.0 | 10 | 5.90 | 0.98 | 7.85 | 2.95 | 35.5 | 125 | 250 | 1.490 | 0.93 | 6.2 | 0.80 |
| Fiber R | 0.33 | 3.2 | 4 | 9.50 | 4.25 | 18.00 | 2.97 | 30.9 | 125 | 250 | 1.343 | 1.21 | 8.4 | 17.2 |
| Fiber S | 0.33 | 3.2 | 6 | 9.41 | 2.50 | 14.40 | 2.94 | 31.4 | 125 | 250 | 1.343 | 1.06 | 8.4 | 10.2 |
| Fiber T | 0.33 | 3.2 | 8 | 9.64 | 1.89 | 13.42 | 3.01 | 32.8 | 125 | 250 | 1.343 | 0.97 | 8.4 | 7.8 |
| Fiber U | 0.33 | 3.2 | 10 | 9.48 | 1.36 | 12.20 | 2.96 | 31.4 | 150 | 250 | 1.337 | 0.91 | 8.4 | 7.0 |
| Fiber V | 0.33 | 3.2 | 10 | 9.54 | 1.38 | 12.30 | 2.98 | 31.6 | 125 | 350 | 1.339 | 0.92 | 8.4 | 7.2 |
| Fiber W | 0.33 | 3.2 | 10 | 9.31 | 1.54 | 12.39 | 2.96 | 35.5 | 125 | 250 | 1.305 | 0.90 | 8.4 | 4.71 |

### A First Example

In a first example, a holey single-mode optical fiber having 10 holes 13 around a core 11 as shown in FIG. 1A was manufactured. In a cross section of the optical fiber, the holes 13 are disposed in a single concentric circle.

Parameters such as a core radius and a core Δ are shown in fibers A to E of Table 1. The fiber E is an optical fiber manufactured for comparison, in which a core diameter and a core Δ are the same and thereby holes are not present. In Table 1, both a zero-dispersion and a cable cut-off wavelength are shown.

As can be seen from the result, when the air-filling fraction F is 50% or less, it satisfies the cable cut-off wavelength of 1.0 μm or less. In addition, the air-filling fraction F of 50.1% in the fiber C becomes 50% in two significant digits and satisfies the above-described “air-filling fraction is 50% or less”. On the other hand, as shown in the result of the fiber E, when the air-filling fraction F is 54.1%, that is, when it exceeds 50%, it can be seen that the cable cut-off wavelength exceeds 1.0 μm. In addition, it can be seen that the zero-dispersion wavelength is within a range of 1260 to 1460 nm in all optical fibers.

Results obtained by measuring a mode field diameter (MFD) with respect to the fibers A to E are shown in Table 2. With respect to the MFD, since a direction in the MFD of the HAF has an angular dependency, the average MFD was measured by using VA (Variable Aperture) method. As can be seen from Table 2, the MFD is 7.2 μm or more at a wavelength of 1.31 μm of the fiber A to the fiber D, and therefore it satisfies a requirement of 6.5 μm or more.

TABLE 2
MFD [μm] of each fiber

Measurement wavelength
[μm]

| | 1.06 | 1.24 | 1.31 | 1.48 | 1.55 | 1.625 |
|---|---|---|---|---|---|---|
| Fiber A | 6.5 | 7.1 | 7.4 | 7.9 | 8.2 | 8.3 |
| Fiber B | 6.5 | 7.2 | 7.4 | 7.8 | 8.0 | 8.2 |
| Fiber C | 6.5 | 7.1 | 7.3 | 7.6 | 7.8 | 8.0 |
| Fiber D | 6.5 | 7.0 | 7.2 | 7.5 | 7.6 | 7.8 |
| Fiber E | 6.7 | 7.5 | 7.9 | 9.0 | 9.6 | 10.1 |

Results obtained by measuring a bending loss with respect to the fibers A to E are shown in Table 3. As can be seen from Table 3, in all of the fibers A to E, a bending radius r was 10 mm, and a bending loss was 10 dB/m or less at a wavelength of 1.625 μm. In particular, when an air-filling fraction F was 46% or more, the bending loss was 1 dB/m or less.

TABLE 3
Bending loss [dB/m] at a bending radius r of 10 mm of each fiber

| Measurement wavelength[μm] | 1.55 | 1.625 |
|---|---|---|
| Fiber A | 1.7 | 2.7 |
| Fiber B | 0.3 | 0.6 |
| Fiber C | 0.2 | 0.5 |
| Fiber D | 0.05 | 0.1 |
| Fiber E | >100 | >100 |

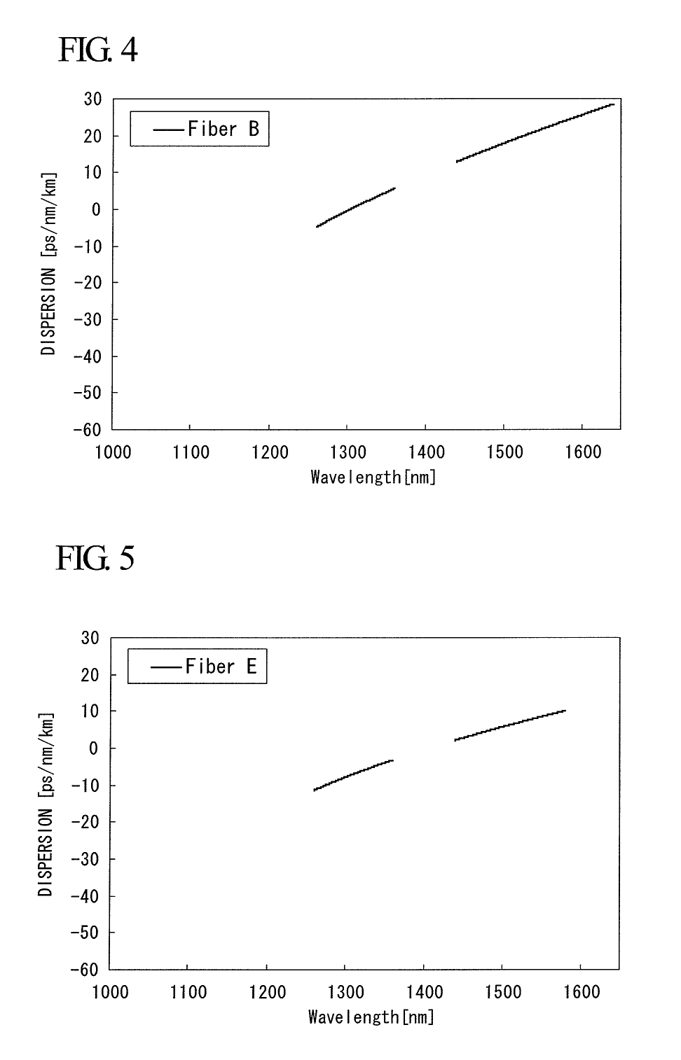

Results of a dispersion measurement with respect to the fiber B and the fiber E are shown in FIGS. 4 and 5. The measurements were performed at a wavelength near 1.31 μm and a wavelength near 1.55 μm. A chromatic dispersion and a dispersion slope at a wavelength of 1.31 μm and a wavelength of 1.55 μm are shown in Table 4.

TABLE 4
Dispersion measurement result of each fiber

| Fiber ID | |
|---|---|
| Fiber B | Fiber E |

Wavelength [nm]

| | 1310 | 1550 | 1310 | 1550 |
|---|---|---|---|---|
| Chromatic dispersion | 0.68 | 21.8 | −7.03 | 8.5 |
| [ps/nm/km] | | | | |
| Dispersion | 0.103 | 0.076 | 0.081 | 0.053 |
| slope[ps/nm²/km] | | | | |

As shown in FIG. 4 and Table 4, in the fiber B, a large dispersion value of 20 ps/nm/km or more was obtained at a wavelength band of 1.55 μm (1530 to 1625 nm). In addition, although a dispersion value at a wavelength of 1.0 μm (1.0 to 1.2 μm) was not directly measured, a dispersion value having a large absolute value of −10 ps/nm/km or less can be obtained.

In addition, the fiber E shown in FIG. 5 is an optical fiber not having holes. From the comparison between the fibers B and E, as shown in Table 1, it can be seen that a zero-dispersion wavelength shifts toward a short wavelength side as holes are added. The zero-dispersion wavelength of the fiber B and the fiber E are 1304 nm and 1407 nm, respectively, and thereby the fiber B shifts toward a short wavelength by 103 nm.

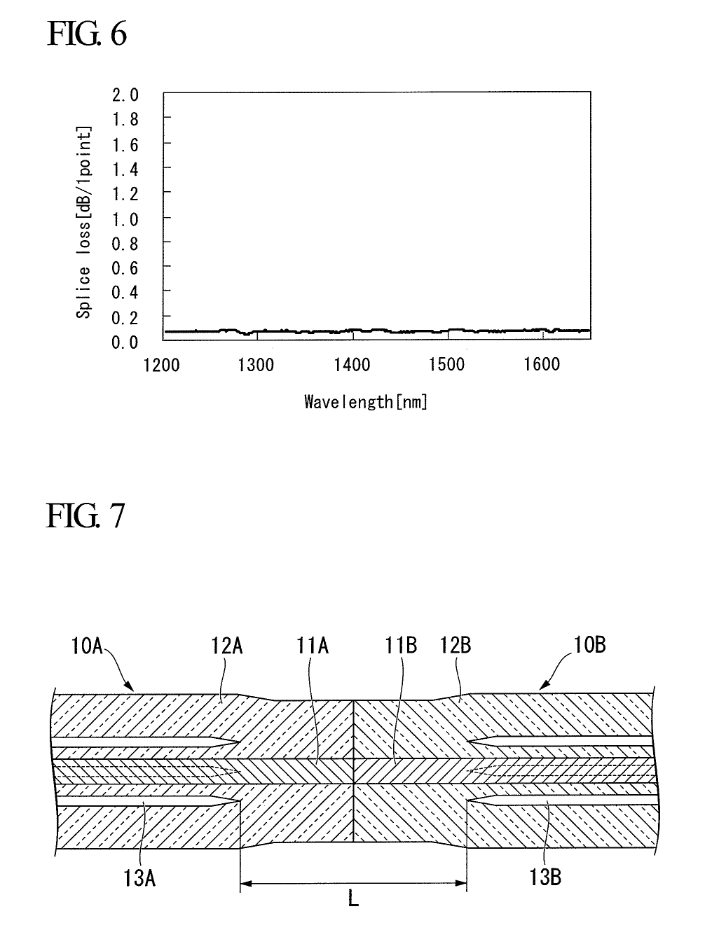

In addition, results obtained by evaluating a splice loss of the fiber B are shown in FIGS. 6 to 8.

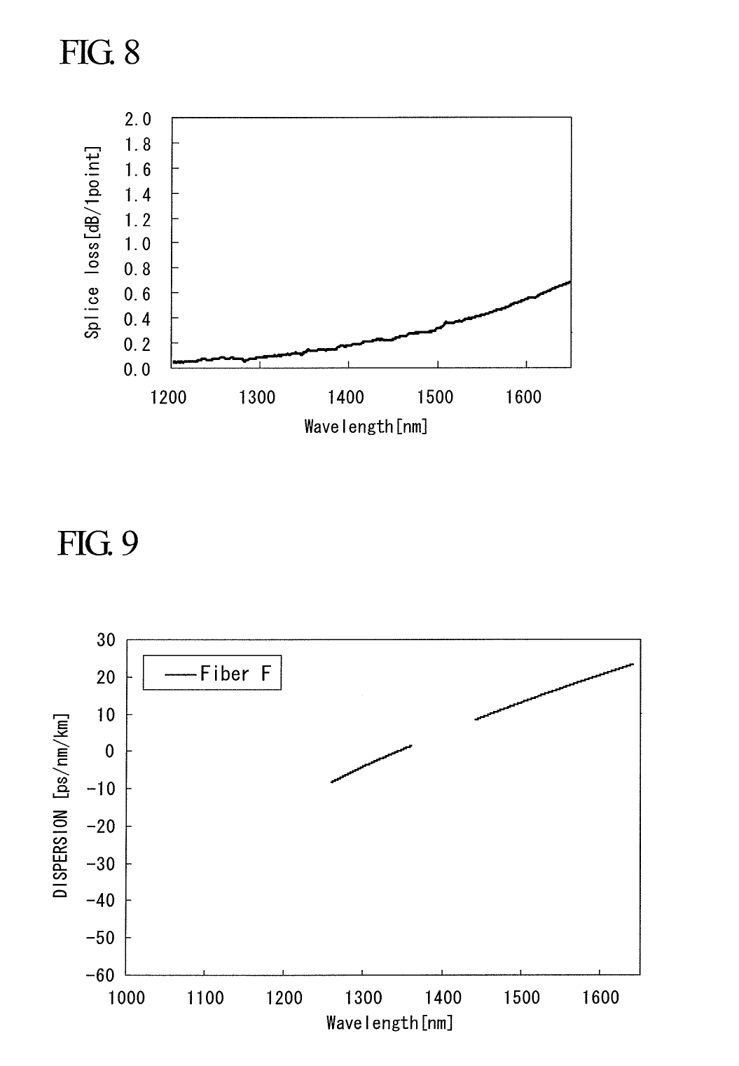

FIG. 6 shows a result obtained by measuring a wavelength dependency of the splice loss per one point with respect to a case where when the fibers B are fusion-spliced to each other, they are spliced with reference to Non-Patent Document 3. In addition, FIG. 8 shows a result obtained by measuring a wavelength dependency of the splice loss per one point with respect to a case where holes are collapsed in a distance L of about 400 μm at a fusion splicing portion as shown in FIG. 7.

As shown in FIGS. 6 and 8, it can be seen that the fibers B can be spliced to each other with a splice loss of 0.7 dB/point or less even at a wavelength of 1.625 μm. When it is spliced with reference to Non-Patent Document 3, it is possible to splice at about 0.1 dB/point.

In addition, with respect to a case where a PCF having three hole layers (the number of holes is 36) was spliced at the same condition as described above for the comparison, when the holes were collapsed in a distance of about 400 μm, the splice loss was 10 dB/point or more, and when it was spliced with reference to Non-Patent Document 3, the splice loss was 0.2 dB/point. From the result described above, it could be seen that since a core having a large refraction index is provided at a center of a fiber, the holey single-mode optical fiber of the present invention can be spliced with a low splice loss.

In addition, WDM transmission was performed with respect to the fiber B over 20 km. Two wavelengths of 1.0 μm and 1.55 μm were used as transmission wavelengths. At the wavelength of 1.0 μm, a YbFA (Yb doped fiber amplifier) was used as an amplifier. Both of the two wavelengths were modulated by using LN (lithium niobate) modulator to 10 Gbps. The transmission was possible at both the wavelengths.

The fiber B has a zero-dispersion wavelength of 1304 nm. This value is within a zero-dispersion wavelength range of 1300 to 1324 nm of a single-mode fiber compliant to an international standard ITU-T recommendation G.652. Therefore, the fiber B is excellent in a compatibility with an existing transmission system. Similarly, a zero-dispersion wavelength (1311 nm) of the fiber A is also within a zero-dispersion wavelength range (1300 to 1324 nm) of a single-mode fiber compliant to an international standard ITU-T recommendation G.652. Therefore, the fiber B is excellent in a compatibility with an existing transmission system.

### A Second Example

As a second example, an HAF was manufactured with a parameter shown in fibers F to I of Table 1. The fiber I is an optical fiber manufactured for comparison, in which a core diameter and a core Δ are the same and holes are not present.

From Table 1, it can be seen that a cable cut-off wavelength is 1.0 μm or less and a zero-dispersion wavelength is between 1260 and 1460 nm, and thereby the requirement was satisfied. Measurement results of an MFD and a bending loss of each of the fibers is shown in Tables 5 and 6.

TABLE 5
MFD [μm] of each fiber

Measurement wavelength
[μm]

| | 1.06 | 1.24 | 1.31 | 1.48 | 1.55 | 1.625 |
|---|---|---|---|---|---|---|
| Fiber F | 7.1 | 8.1 | 8.4 | 9.3 | 9.7 | 9.9 |
| Fiber G | 7.1 | 8.0 | 8.4 | 9.2 | 9.5 | 9.7 |
| Fiber H | 7.1 | 8.0 | 8.4 | 9.2 | 9.5 | 9.5 |
| Fiber I | 7.1 | 8.3 | 8.7 | 10.0 | 10.7 | 11.4 |

TABLE 6
Bending loss [dB/m] at a bending radius r of 10 mm of each fiber

| Measurement wavelength [μm] | 1.55 | 1.625 |
|---|---|---|
| Fiber F | 26.8 | 37.4 |
| Fiber G | 6.5 | 6.8 |
| Fiber H | 1.6 | 4.7 |
| Fiber I | >100 | >100 |

As shown in Table 5, a mode field diameter of a wavelength of 1.31 μm was a large value such as 8.4 μm or more. As shown in Table 6, a bending loss at a wavelength of 1.625 μm and a bending radius r of 10 mm was a value of 10 dB/m or more in the fiber F having an air-filling fraction of 21.7%. In the fibers G and H having an air-filling fraction of 30% or more, 10 dB/m can be obtained. Therefore, when an air-filling fraction is 30% or more, it is possible to satisfy a bending loss at a wavelength of 1.625 μm and a bending radius r of 10 mm.

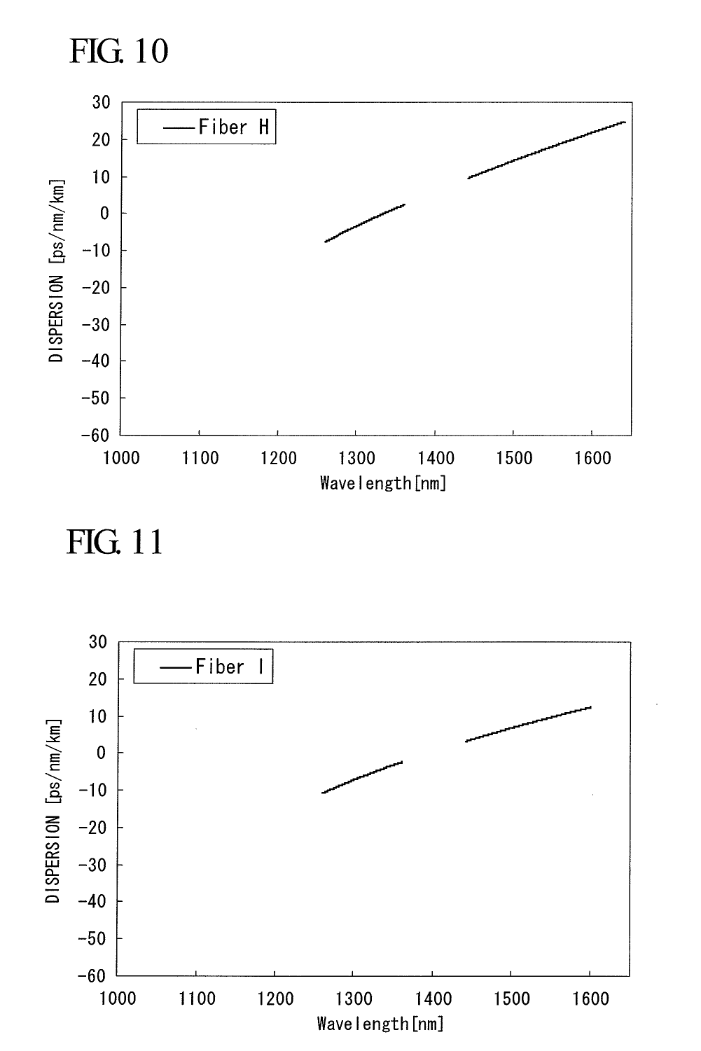

Results of a dispersion measurement with respect to the fiber F, the fiber H, and the fiber I are shown in FIGS. 9 to 11. The measurements were performed at a wavelength near 1.31 μm and a wavelength near 1.55 μm. A chromatic dispersion and a dispersion slope at a wavelength of 1.31 μm and a wavelength of 1.55 μm are shown in Table 7.

TABLE 7
Dispersion measurement result of each fiber

| | Fiber ID | | | | | |
|---|---|---|---|---|---|---|
| | Fiber F | | Fiber H | | Fiber I | |
| | Wavelength[μm] | | | | | |
| | 1310 | 1550 | 1310 | 1550 | 1310 | 1550 |
| Chromatic | −3.11 | 16.9 | −2.29 | 18.2 | −6.29 | 9.7 |
| dispersion | | | | | | |
| [ps/nm/km] | | | | | | |
| Dispersion slope | 0.097 | 0.073 | 0.100 | 0.075 | 0.084 | 0.055 |
| [ps/nm²/km] | | | | | | |

As shown in FIGS. 9 to 11, in the fibers F and H, a large dispersion value of 15 ps/nm/km or more was obtained at a wavelength band of 1.55 μm (1530 to 1625 nm). In addition, although a dispersion value at a wavelength of 1.0 μm (1.0 to 1.2 μm) was not directly measured, a dispersion value having a large absolute value of −10 ps/nm/km or less can be obtained in both fibers. In addition, the fiber I is an optical fiber not having holes. From the comparison between the fibers F, H and I, it can be seen that a zero-dispersion wavelength shifts toward a short wavelength side as holes are added.

The zero-dispersion wavelengths of the fibers F, H, and I were 1343 nm, 1334 nm, and 1393 nm, respectively. That is, the fiber F and H were shifted toward a short wavelength by 50 nm and 59 nm, respectively, compared to the fiber I.

In addition, microbending characteristics of the fibers F to H were evaluated. The evaluation was performed by a method, in which #360 sandpaper is wound around a bobbin having a diameter of 400 mm with a winding tension of 100 gf, a microbend is generated at an optical fiber having a length of 600 m, the size of loss increase at wavelengths of 1.55 μm and 1.625 μm is measured, and an evaluation is performed, on the basis of a standard IEC TR 62221. A loss increase of a general single-mode optical fiber was measured as a comparison target by the same method as described above.

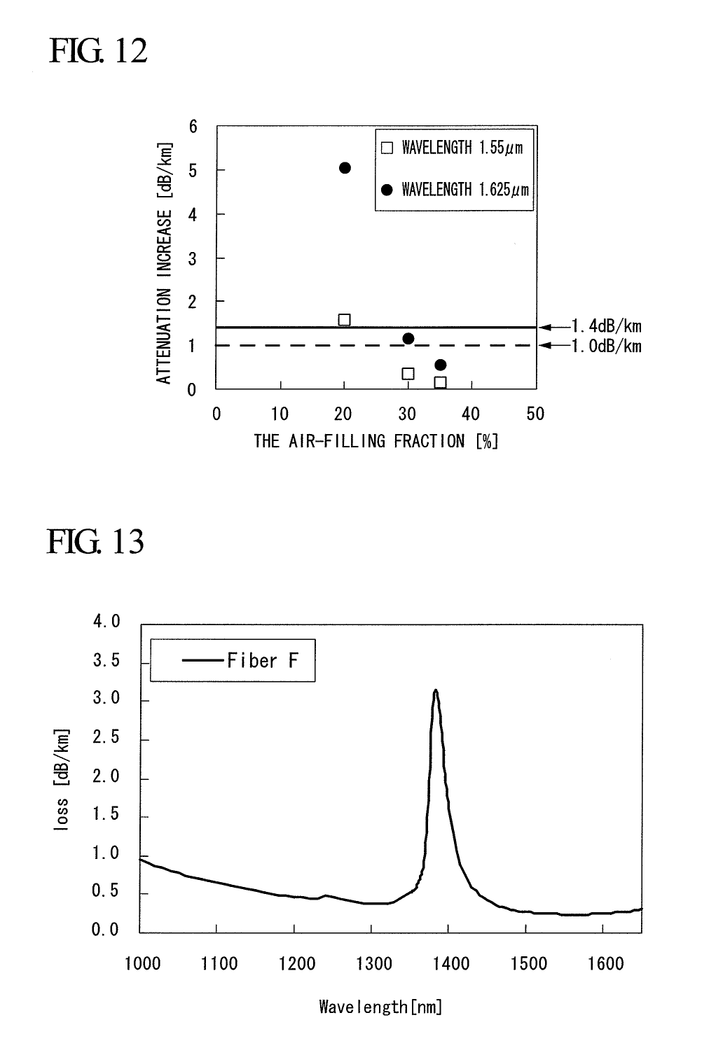

FIG. 12 shows a graph illustrating a result of evaluation on a microbending characteristic of the fiber F (air-filling fraction is 21.7%), the fiber G (air-filling fraction is 31.8%) and the fiber H (air-filling fraction is 35.5%), in which a loss increase is plotted with respect to an air-filling fraction.

In FIG. 12, a horizontal line is an evaluation result of a general single-mode optical fiber (not having holes), and a loss increase at each of the wavelengths of 1.5 μm and 1.625 μm was 1.0 dB/km and 1.4 dB/km. As shown in FIG. 12, it can be seen that when the air-filling fraction is 30% or more, a loss increase thereof is smaller than that of a general single-mode optical fiber. Therefore, when the air-filling fraction is made to be 30% or more, it is possible to make the loss increase caused by the microbending to be smaller than that of a general single-mode fiber.

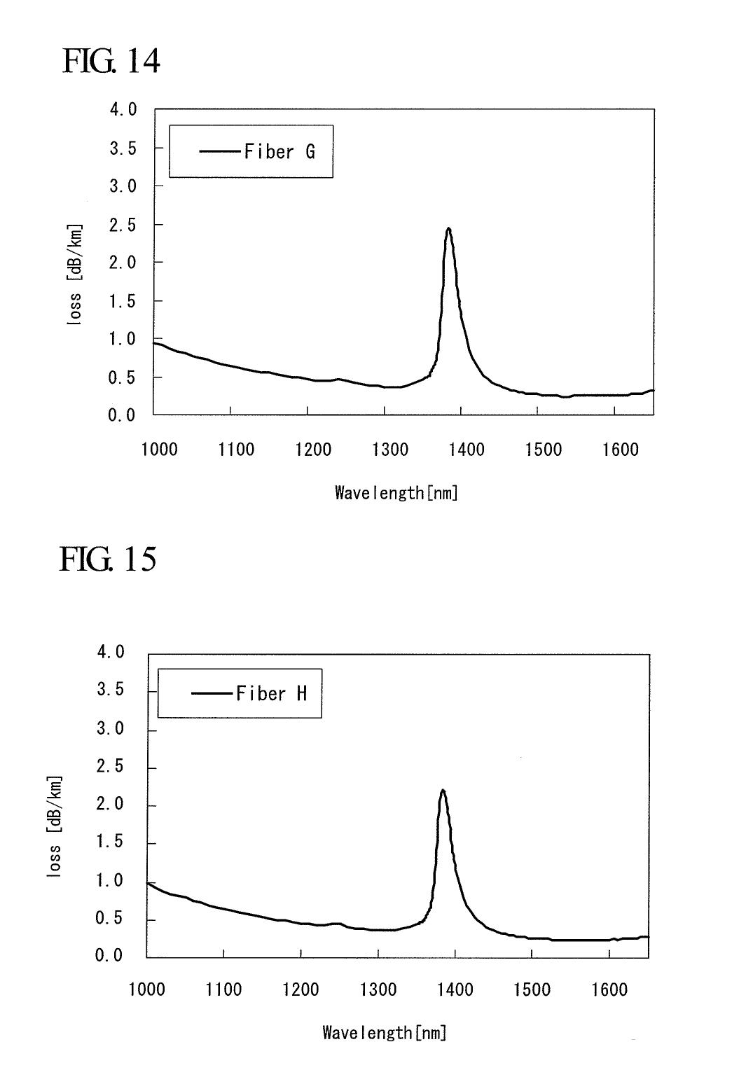

In addition, an evaluation on an attenuation characteristic of each of the fibers F to H was performed. A result thereof is shown in FIGS. 13 to 15. As shown in FIGS. 13 to 15, a low loss is obtained in the fiber F to fiber H at each wavelength. The reason why the loss becomes high at a wavelength near 1380 nm is that absorption caused by a hydroxyl (OH) group occurs. With respect to a loss at a wavelength of 1550 nm, the fibers F to H obtain a loss of 0.25 dB/km or less.

### A Third Example

As a third example, an HAF was manufactured with a parameter shown in fibers J and K of Table 1. As a hole position, Rᵢₙ/r₁ was 1.81 and 2.04. As can be seen from the result of Table 1, in the fiber J where holes are disposed closely to a core, a zero-dispersion wavelength was remarkably short, that is, 1223 nm. In the fiber K, the zero-dispersion wavelength is 1262 nm and therefore it satisfies the requirement range. Therefore, it is considered that in a hole position, when Rᵢₙ/r₁ is not 2.0 or more, it satisfies the requirement range of a zero-dispersion wavelength.

### A Fourth Example

As a fourth example, an HAF was manufactured with a parameter shown in fibers L and M of Table 1. As a hole position, Rᵢₙ/r₁ was 3.48 and 3.70. As can be seen from the result of Table 1, in the fiber M where holes are disposed far away from a core, a cable cut-off wavelength becomes long, that is, 1.15 μm and 1.0 μm or more. In the fiber L, the cable cut-off wavelength is 0.99 μm and this barely satisfies the requirement range. Therefore, it is considered that in a hole position, when Rᵢₙ/r₁ is not 3.50 or less, it does not satisfy the requirement range of the cable cut-off wavelength. Even when Rᵢₙ/r₁ becomes larger than 3.50, if the air-filling fraction is small, the cable cut-off wavelength can be 1.0 μm or less, but at this time, a bending loss at a wavelength of 1.625 μm and a bending radius r of 10 mm exceeds 10 dB/m.

### A Fifth Example

As a fifth example, an experimental production was performed to determine ranges of a core radius and a core Δ. As shown in FIG. 2, a region satisfying a cut-off wavelength and an MFD is diagonally distributed in a direction from “a core radius: large and a core Δ: small” to “a core radius: small and a core Δ: large”.

Here, four optical fibers of Fibers N to Q of Table 1 were manufactured to determine the limits of the two parameters.

First, to determine a limit of “a core radius: large and a core Δ: small”, the fibers N and O were manufactured. As can be seen from results of Table 1, in the fiber N, a bending loss at a wavelength of 1.625 μm and a bending radius r of 10 mm becomes 10 dB/m or more, and this does not satisfy the requirement, but the fiber O satisfies the requirement. Therefore, it is necessary that the core radius is 3.2 μm or less, and the core Δ is 0.30% or more.

In addition, from a measurement on an attenuation characteristic of the fiber N, it could be seen that an excessive loss is generated at a wavelength longer than a wavelength of 1550 nm. This is considered since a field becomes broad at a long wavelength band and a confinement of a core is weak. In the fiber O, an excessive loss increase at a long wavelength was not seen.

Next, to determine a limit of “a core radius: small and a core Δ: large”, the fibers P and Q were manufactured. As can be seen from the results of Table 1, in the fiber Q, a zero-dispersion wavelength is larger than 1460 nm, an MFD (at 1.31 μm) becomes less than 6.5 μm and thereby the fiber Q does not satisfy the requirement but the fiber P satisfies the requirement. Therefore, it is necessary that the core radius is 2.2 μm or more and the core Δ is 0.56% or less.

From the results described above, when the core radius r₁ and the core Δ are within the range described below, it is possible to satisfy the requirements.

2.2 μm≦r₁≦3.2 μm

0.30%≦core Δ≦0.56%

### A Sixth Example

As a sixth example, HAFs having different numbers of holes were manufactured to determine the number of holes. The HAFs were manufactured with a parameter shown in fibers R to T of Table 1. FIGS. 16 to 18 show schematic cross sectional views of the fibers R, S, and T, respectively. As can be seen from the results of Table 1, in the fibers R and S of which the number of holes is 6 or less, a cable cut-off wavelength is longer than 1.0 μm and therefore it does not satisfy the requirement. In addition, in the fiber R of which the number of holes is 4, it was confirmed that a transmission loss becomes excessively large at a long wavelength of 1550 nm or more. In the fibers S and T, the excessive increase of the transmission loss was not found. At the fiber T of which the number of holes is 8, a cable cut-off wavelength is 1.0 μm or less and therefore it satisfies the requirement. Also, in the fibers R and S, when the air-filling fraction is made to be small, the cable cut-off wavelength becomes 1.0 μm or less, but the bending loss at a wavelength of 1.625 μm and a bending radius r of 10 mm becomes large, and therefore it does not satisfy the requirement.

From the results described above, it is necessary that the number of holes is 8 or more. In addition, an upper limit of the number of holes is correlated with cost issues, but it is preferable that the upper limit is 18 or less from a view point that 18 holes formed in two layers are necessary in a PCF. In this example, there is described only a case where the number of holes is an even number, but it may be an odd number. In a case where the number of holes is small (6 or less), it is preferable to have four-times or six-times symmetry in an even number. However, in a case where the number of holes is 8 or more, since a core deformation or a mode field deformation, which are caused by holes, are made to be equal, even when the number of holes is an odd number or the holes do not have four-times or six-times symmetry, there is no problem.

In addition, as an optical fiber of recent years strong against a bending loss, as disclosed in NPT 5, a method of decreasing a refraction index of the periphery of the core by a microstructure of small bubbles has been disclosed. In the present invention, the hole layer is limited to one layer, but even in an optical fiber having the microstructure of small bubbles, when an air-filling fraction in a structure where the microstructure is provided, and a width where the holes are provided are the same, it may obtain an equal effect. In the present invention, a width (Rₒᵤₜ-Rᵢₙ) in a radial direction where the hole layer is provided is preferably 0.6 μm≦Rₒᵤₜ-Rᵢₙ≦7.35 μm.

### A Seventh Example

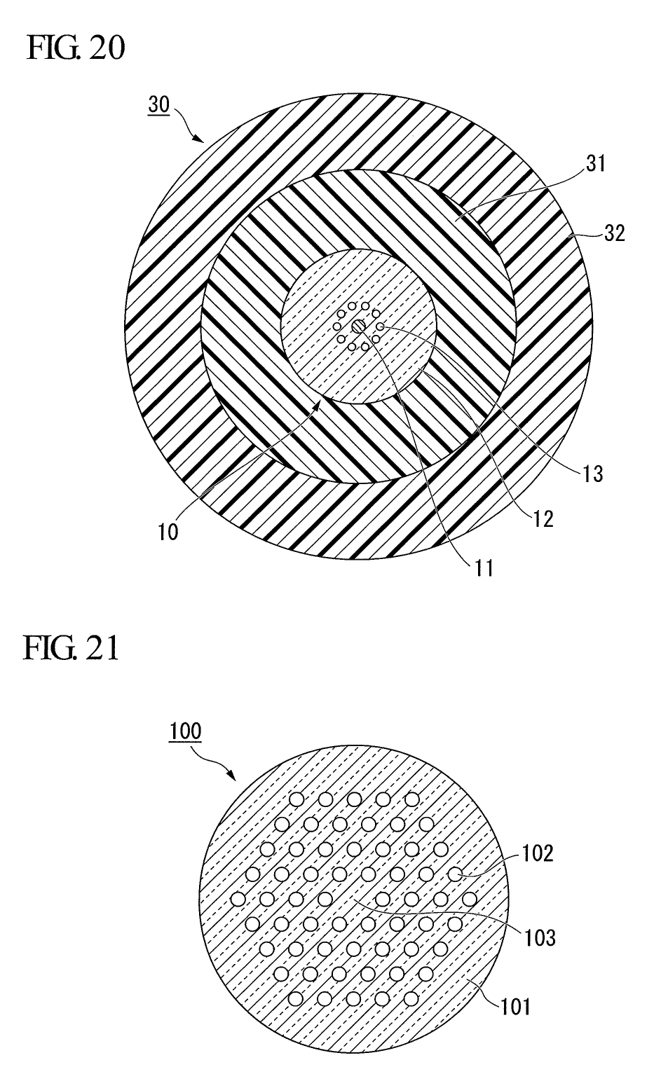

As a seventh example, a fiber U was manufactured with substantially the same parameter as that of the fiber G manufactured in the second example except for an outer diameter of a fiber. The outer diameter of the fiber U was set to 150 μm. In addition, similarly, a fiber V was manufactured with substantially the same parameter as that of the fiber G except for an outer diameter of a coating. The outer diameter of the coating was set to 350 μm. The fiber used in this example except for the fiber V has a double-layered structure of a primary coating 21 and a secondary coating 22 as shown in FIG. 19 and an outer diameter of a first layer is set to 195 μm and an outer diameter of a second layer is set to 250 μm. As shown in FIG. 20, the fiber V has a double-layered structure of a primary coating 31 and a secondary coating 32 and an outer diameter of a first layer is set to 220 μm and an outer diameter of a second layer is set to 350 μm. With respect to the fiber U and the fiber V, an evaluation on a microbend was performed by the same method as in the second example. In the fiber U, the loss increase at a wavelength of 1.625 μm was improved to 0.30 dB/km (at the fiber G, 0.55 dB/km). In addition, in the fiber V, the loss increase at a wavelength of 1.625 μm was improved to 0.15 dB/km.

### Eighth Example

As an eighth example, a fiber W was manufactured similarly to the fiber H except that a core is made of pure silica, and a clad excluding the holes is made of a fluorine-added silica glass having a refraction index lower than that of the pure silica core. A structure parameter and a main optical characteristic are shown in Table 1. The fiber W has substantially the same value as that of the fiber H except that the zero-dispersion wavelength thereof was 1305 nm.

With respect to the fiber W, a transmission loss at a wavelength of 1000 nm was measured similarly to the fiber H. The transmission loss of the fiber H at the wavelength of 1000 nm was 1.0 dB/km from a result of an attenuation characteristic as shown in FIG. 15, and in the fiber W, the transmission loss was 0.87 dB/km. That is, in the fiber W, it was possible to decrease a loss at a short wavelength side where the transmission loss becomes large. This is because the core was made of pure silica and thereby it was possible to decrease a loss caused by a Rayleigh scattering.

By designating a structure parameter described below through the above-described examples, it was possible to satisfy the requirement where a cable cut-off wavelength is 1.0 μm or less, a zero-dispersion wavelength is 1260 to 1460 nm, a bending loss characteristic at a bending radius of 10 mm is 10 dB/m or less, and an MFD at a wavelength of 1.31 μm is 6.5 μm or more.

A core radius r₁: 2.2 μm≦r₁≦3.2 μm

A core Δ: 0.3%≦core Δ≦0.56%

A hole position Rᵢₙ/r₁: 2.0 Rᵢₙ/r₁≦3.5

An air-filling fraction F: 30%≦F≦50%

1. A holey single-mode optical fiber comprising a core not having holes, and a clad having holes extending in a longitudinal direction, in which a refraction index of the core is larger than that of a portion of the clad other than the holes, wherein:
a radius r₁ of the core is within a range of 2.2 to 3.2 μm;
a relative refraction index difference Δ of the core to the clad is within a range of 0.3 to 0.56%;
a distance Rᵢₙ between a center of the core and an inner edge of a hole is 2.0 to 3.5 times the radius r₁ of the core;
an air-filling fraction F is within a range of 30 to 50%;
a cable cut-off wavelength is 1.0 μm or less;
a zero-dispersion wavelength is within a range of 1260 to 1460 nm; and
a bending loss characteristic at a bending radius of 10 mm is 10 dB/m or less.

2. The holey single-mode optical fiber according to claim 1,
wherein in the clad, 8 or more holes are disposed to be equally spaced in a single concentric circle.

3. The holey single-mode optical fiber according to claim 1,
wherein a mode field diameter at a wavelength of 1.31 μm is 6.5 μm or more.

4. The holey single-mode optical fiber according to claim 1,
wherein a loss at a wavelength of 1550 nm is 0.3 dB/km or less.

5. The holey single-mode optical fiber according to claim 1,
wherein a splice loss per one fusion splicing place with another optical fiber is 1.0 dB or less.

6. The holey single-mode optical fiber according to claim 1,
wherein a bending loss characteristic at a bending radius of 10 mm is 1 dB/m or less.

7. The holey single-mode optical fiber according to claim 1,
wherein the zero-dispersion wavelength is within a range of 1300 to 1324 nm.

8. The holey single-mode optical fiber according to claim 1,
wherein an outer diameter of the clad is 150 μm or more.

9. The holey single-mode optical fiber according to claim 1, further comprising:
a coating covering an outer circumference of the clad,
wherein an outer diameter of the coating is 350 μm or more.

10. The holey single-mode optical fiber according to claim 1,
wherein the core is made of pure silica.

11. An optical transmission system including the holey single-mode optical fiber according to claim 1,
wherein a wavelength division multiplexing transmission is performed within a wavelength range of 1.0 to 1.625 μm.
